(19) United States
(12) Patent Application Publication
(10) Pub. No.: US 2022/0318024 A1
(43) Pub. Date: Oct. 6, 2022

(54) SETTING TERMINAL, SETTING METHOD AND PROGRAM

(71) Applicant: PFU LIMITED, Ishikawa (JP)

(72) Inventors: Hiroyuki SAKAMOTO, Ishikawa (JP); Koutarou MOTOI, Kanagawa (JP); Daisuke KASAHARA, Kanagawa (JP)

(21) Appl. No.: 17/616,058

(22) PCT Filed: May 14, 2020
(86) PCT No.: PCT/JP2020/019209

§ 371 Date: Apr. 11, 2022

(30) Foreign Application Priority Data
Jun. 3, 2019 (JP) 2019-103484

(51) Int. Cl. G06F 9/4401; G06V 30/148

(52) U.S. Cl. CPC G06F 9/4411; G06V 30/153; G06F 9/4416

(57) ABSTRACT

Provided is a setting management system that makes setting operation of a device efficient. A setting terminal includes a storage unit that stores a scenario of a setting process related to a device to be set, an input unit that is USB connected to the device to be set and inputs information to the device to be set, a progress determination unit that determines a progress of a scenario of a setting process based on timing of an input by the input unit and the scenario stored in the storage unit, and a setting operation unit that inputs, to the device to be set, setting information via the input unit according to the progress of the scenario determined by the progress determination unit.

### TECHNICAL FIELD

The present invention relates to a setting terminal, a setting method, and a program.

### BACKGROUND ART

For example, Patent Literature 1 discloses a support device 100 that analyzes control information describing in advance a series of mouse operations for executing setting operation of a target PC, generates a pseudo operation signal for performing a mouse operation on the target PC based on an analysis result to transmit the generated operation signal to the target device to execute the mouse operation on the target PC.

Furthermore, Patent Literature 2 discloses a management device 2 including a storage unit 16 that stores a plurality of activation programs 17, a configuration information acquisition unit 32 that acquires configuration information of one information processing device 3 among the plurality of information processing devices 3, a selection unit 33 that selects the activation program 17 corresponding to one information processing device 3 from the plurality of activation programs 17 stored in the storage unit 16 based on the acquired configuration information, and a transmission unit 34 that transmits the activation program 17 selected by the selection unit 33 to one information processing device 3.

In addition, Patent Literature 3 discloses an information processing device in which the screen comparison/confirmation device 12 and the control device 2 cooperate with each other to automatically perform key/mouse input instead of manual operation in a scene where manual key/mouse input is received in a short time.

### CITATION LIST

### Patent Literature

Patent Literature 1: JP 2013-168072 A

Patent Literature 2: JP 2015-148861 A

Patent Literature 3: JP 2014-049005 A

### SUMMARY OF THE INVENTION

### Technical Problems

An object is to provide a setting management system that makes setting operation of a device efficient.

### Solution to Problems

A setting terminal according to the present invention includes a storage unit that stores a scenario of a setting process related to a device to be set, an input unit that is USB connected to the device to be set and inputs information to the device to be set, a progress determination unit that determines a progress of a scenario of a setting process based on timing of an input by the input unit and the scenario stored in the storage unit, and a setting operation unit that inputs, to the device to be set, setting information via the input unit according to the progress of the scenario determined by the progress determination unit.

Preferably, the setting information includes information to be input before an operating system is activated, and wherein the input unit emulates a keyboard input and inputs setting information to the device to be set.

Preferably, the setting terminal includes an imaging unit that photographs a display of the device to be set, wherein the progress determination unit determines a progress of a setting process based on a photographed image captured by the imaging unit.

Preferably, the input unit includes a plurality of input devices, wherein the imaging unit includes a plurality of imaging devices, wherein the setting operation unit inputs setting information to a plurality of devices to be set in parallel via the plurality of input devices, and wherein the progress determination unit determines a progress of a setting process of each of the plurality of devices to be set based on a photographed image captured by each of the plurality of imaging devices.

Preferably, the setting terminal further includes an identification information acquisition unit that acquires device identification information from the devices to be set, wherein the setting operation unit inputs, to the devices to be set via the input unit, setting information unique to respective pieces of device identification information acquired by the identification information acquisition unit.

Preferably, the setting terminal further includes a network connection unit connected to the devices to be set via a LAN cable, wherein the setting operation unit inputs, via the input unit, setting information unique to each of the plurality of devices to be set, and wherein the setting operation unit distributes, via the network connection unit, a master image to the plurality of devices to be set.

Preferably, the progress determination unit performs a character recognition process on an image captured by the imaging unit, extracts a character string, and determines a progress of a scenario based on the extracted character string.

Preferably, the progress determination unit outputs a warning when a predetermined character string is not extracted by predetermined timing defined by a scenario stored in the storage unit.

Furthermore, a setting method according to the present invention includes a first input step of performing a USB connection with a device to be set and inputting setting information to the device to be set, a progress determination step of determining a progress of a scenario of a setting process based on timing of an input by the first input step and a scenario of a setting process related to the device to be set, and a second input step of inputting next setting information to the device to be set according to the progress of the scenario determined in the progress determination step.

In addition, a program according to the present invention causes a computer to execute a first input step of performing a USB connection with a device to be set and inputting setting information to the device to be set, a progress determination step of determining a progress of a scenario of a setting process based on timing of an input by the first input step and a scenario of a setting process related to the device to be set, and a second input step of inputting next setting information to the device to be set according to the progress of the scenario determined in the progress determination step.

### Advantageous Effects of Invention

The setting operation of the device can be made efficient.

### BRIEF DESCRIPTION OF DRAWINGS

FIG. 1 is a diagram illustrating an overall configuration of a setting management system 1.

FIG. 2 is a diagram illustrating a hardware configuration of a setting terminal 3.

FIG. 3 is a diagram illustrating a functional configuration of a management server 2A.

FIG. 4 is a diagram illustrating the relationship between the functional configuration of a print control PC 50 and a printing device 52.

FIG. 5 is a diagram illustrating a relationship between a functional configuration of a setting terminal 3 and a device to be set 9 with which a carriage 4 is loaded.

FIG. 6 is a flowchart describing an entire process in the setting management system 1.

FIG. 7 is a flowchart describing a setting operation process S30 (first half) in more detail.

FIG. 8 is a flowchart describing a setting operation process S30 (latter half) is more detail.

FIG. 9 is a flowchart describing a label printing process S40 in more detail.

FIG. 10 is a flowchart describing a packing inspection process S50 in more detail.

### DESCRIPTION OF EMBODIMENT

Hereinafter, embodiment of the present invention will be described with reference to the drawings.

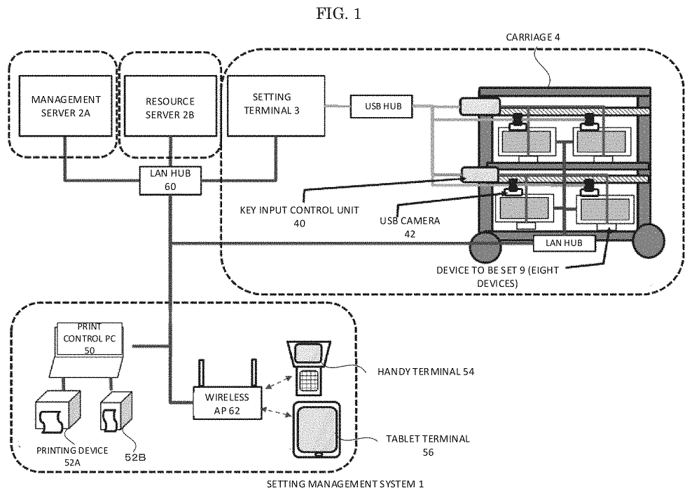

FIG. 1 is a diagram illustrating an overall configuration of a setting management system 1.

As illustrated in FIG. 1, the setting management system 1 includes a management server 2A, a resource server 2B, a setting terminal 3, a carriage 4, a print control personal computer (print control PC) 50, a printing device 52, a handy terminal 54, and a tablet terminal 56, which are connected to each other via a network. The network includes, for example, a LAN cable, a local area network (LAN) hub 60, and a wireless access point (wireless AP) 62.

The management server 2A is a computer terminal that provides setting information and device information necessary for setting operation. For example, the management server 2 manages the entire process including the setting operation by the setting terminal 3 and the printing operation by the printing device 52.

The resource server 2B is a computer terminal that stores resources (a master image and an installation application) necessary for the installation operation. Note that the management server 2A and the resource server 2B may be realized by a single computer terminal.

The setting terminal 3 is a computer terminal, and performs the setting operation for a plurality of devices to be set 9 (personal computer to be set 9) with which the carriage 4 is loaded in parallel according to an instruction from the management server 2.

The carriage 4 is a carriage which is loaded with the plurality of devices to be set 9. For example, the carriage 4 is a carriage with casters, and can be moved in a state where the carriage is loaded with the plurality of devices to be set 9. In the present example, the carriage 4 can be loaded with eight PCs to be set 9, and moves to at least an unpacking place, a vicinity of the setting terminal 3, a vicinity of the printing device 52, an inspection place, and a packing place.

In addition, a plurality of key input control units 40 and a plurality of USB cameras 42 are prepared in the carriage 4, and are connected to the setting terminal 3 via a USB hub and a USB cable. These key input control units 40 are USB connected to the PCs to be set 9 on a one-to-one basis, and the USB cameras 42 are installed at positions facing the monitors of the plurality of PCs to be set 9.

The print control PC 50 is a computer terminal that controls print processing by the printing device 52, and causes the printing device 52 to execute the print process based on print data provided from the management server 2A. In the present example, a printing device 52A prints a label to be attached to the outer box for packing the device to be set 9 according to the control of the print control PC 50. A printing device 52B prints a label to be attached to the housing of the device to be set 9 according to the control of the print control PC 50.

The handy terminal 54 is a portable computer terminal that inputs identification information (manufacturing machine number) of the device to be set 9. For example, the handy terminal 54 reads the manufacturing machine number of the device to be set 9 in the incoming process, the unpacking/allocation process, the printing process, the inspection process, and the packaging process.

The tablet terminal 56 is a tablet computer terminal that inputs a result of an inspection performed by an inspection person in an inspection process of inspecting the device to be set 9.

The setting management system 1 is effective, for example, when a large-scale personal computer setting operation with a short delivery period occurs and a large amount of setting operation in a short period of time (for example, several thousands to several tens of thousands of vehicles in 2 to 5 months) is performed. As a method for mass-producing the same product, a line production method is known. In the line production method, since processing is performed while flowing the object to be processed with a belt conveyor or the like, it is not suitable for individual correspondence. Specifically, in the setting operation of the personal computer, there are various types of setting information and it is difficult to distinguish the setting information from the appearance, and thus it is difficult to take an individual response in the flow operation.

In the conventional setting operation of the personal computer, there are processes of BIOS setting, restoration of a master image, and individual setting of an operating system (OS), and there are the following problems in realizing efficiency.

Setting of the OS can be automated by utilizing the RPA technology, but restoration of the master image and BIOS setting require the physical keyboard input operation, and thus manual operation occurs.

The manual operation occurs for an operation that cannot be handled by automation on the OS, such as a logon operation at the time of reactivation.

Since only one-to-one control can be performed, the entire state cannot be monitored. In addition, an operation space is required.

There is no means for electronically confirming the BIOS setting result, and visual confirmation is required.

In order to grasp and control the operation progress of each process from arrival to shipment, there are the following problems.

Since the operation progress is controlled for each process, it is necessary to grasp the entire operation progress in conjunction with each process.

Since the progress state is checked manually, a time lag from the actual state occurs, and it is difficult to grasp the situation in real time.

Therefore, in the setting management system 1 of the present embodiment, the automation of the personal computer setting operation and the simultaneous control of the plurality of computers are realized by performing the following control on each process of the personal computer setting operation from the setting terminal 3.

### Automatic Setting

By utilizing a microcomputer board (key input control unit 40) capable of programming processing equivalent to physical key input, input automation of all items that have been manually input so far has been realized, and automatic setting has been realized only by turning on the power supply of the PC to be set 9 for all from BIOS setting to master image restoration and OS setting.

For operations that require visual observation, such as a setting result of BIOS, a screen during automatic setting is captured by USB camera 42, and the setting result was converted into text by utilizing OCR technology, thereby realizing automatic determination.

### Simultaneous Control of Plurality of Devices

The state of each process is monitored by the setting terminal 3 to grasp the progress state.

When an error occurs in the automatic setting, the setting terminal 3 monitors and detects the error.

In order to grasp the progress state of each process, a system has been created in which the management server 2A assigns a process ID (process identification information) for each PC to be set 9 and automatically receives the process ID information from each process at the time of process change.

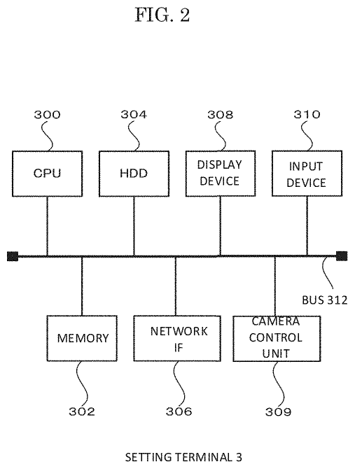

FIG. 2 is a diagram illustrating a hardware configuration of the setting terminal 3.

As illustrated in FIG. 2, the setting terminal 3 includes a CPU 300, a memory 302, an HDD 304, a network interface 306 (network IF 306), a display device 308, a camera control unit 309, and an input device 310, and these components are connected to each other via a path 312.

The CPU 300 is, for example, a central processing unit.

The memory 302 is, for example, a volatile memory, and functions as a main storage device.

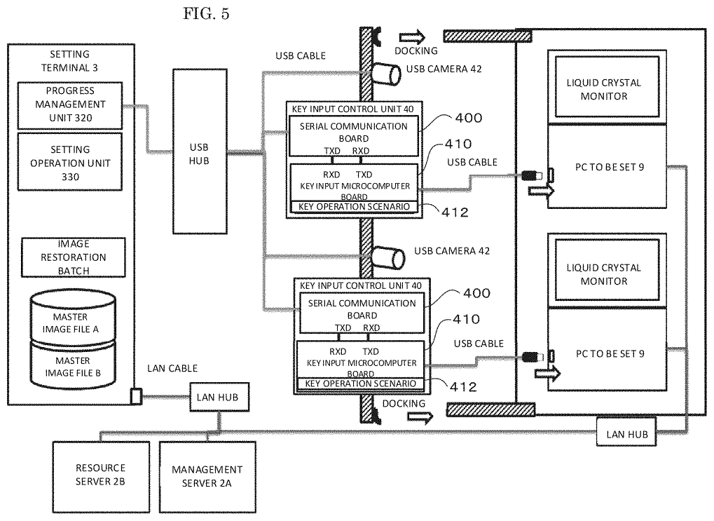

The HDD 304 is, for example, a hard disk drive device to store a computer program (for example, the progress management unit 320 and the setting operation unit 330 in FIG. 5) and other data files as a nonvolatile recording device.

The network IF 306 is an interface for wired or radio communication.

The display device 308 is, for example, a liquid crystal display.

The camera control unit 309 is a control unit that controls the USB camera 42.

The input device 310 is, for example, a mouse and a keyboard touch panel.

Note that the management server 2A and the resource server 2B have, for example, a hardware configuration in which the camera control unit 309 is excluded from the setting terminal 3.

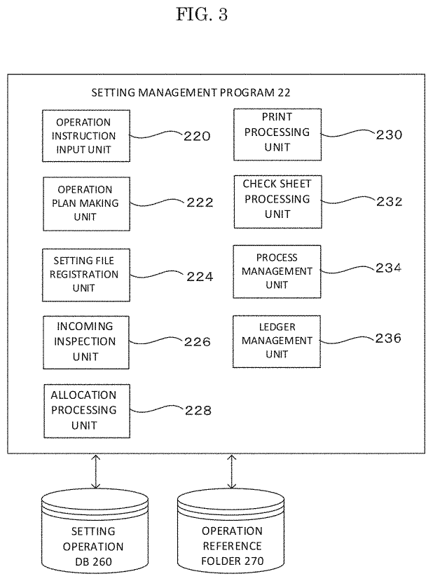

FIG. 3 is a diagram illustrating a functional configuration of the management server 2A.

As illustrated in FIG. 3, the setting management program 22 is installed in the management server 2A, and a setting operation database 260 (setting operation DB 260) and an operation reference folder 270 are configured. The setting management program 22 is stored in a recording medium such as a CO-ROM, for example, and is installed in the management server 2A via the recording medium.

Part or all of the setting management program 22 may be realized by hardware such as an ASIC, or may be realized by using part of a function of an operating system (OS).

The setting operation DB 260 stores setting information of each of the devices to be set 9 and a ledger of the device to be set 9.

The operation reference folder 270 is a folder to which the setting terminal 3, the print control PC 50, and the like can refer, and a data file necessary for the setting operation and the like is placed therein.

The setting management program 22 includes an operation instruction input unit 220, an operation plan making unit 222, a setting file registration unit 224, an incoming inspection unit 226, an allocation processing unit 228, a print processing unit 230, a check sheet processing unit 232, a process management unit 234, and a ledger management unit 236.

In the setting management program 22, the operation instruction input unit 220 takes in setting information from the customer and registers the setting information in the setting operation DB 260.

The operation plan making unit 222 makes a mass production plan for the setting operation and registers the mass production plan in the setting operation DB 260.

The setting file registration unit 224 takes in the update date and the file size of the setting file registered in the setting operation DB 260 to store the registered setting file (setting file provided from the customer) in the operation reference folder 270.

The incoming inspection unit 226 inputs the result of the incoming inspection of the incoming device to be set 9 (PC to be set 9). Specifically, the incoming inspection unit 226 acquires a manufacturing machine number (device identification information) of the device to be set 9 via the handy terminal 54, and registers the acquired manufacturing machine number in the device ledger.

The allocation processing unit 228 allocates the device to be set 9 for which incoming inspection has been completed to the provided setting file. Specifically, the allocation processing unit 228 allocates the setting file which the model matches each device to be set 9 in order of completion of the incoming inspection, and associates the manufacturing machine number of each device ledger with the setting file.

Upon receiving the device identification information (specifically, a manufacturing machine number) in association with the printing device 52, the print processing unit 230 transmits print data including information indicating the user or the installation place of each of the device to be set 9 to the printing device 52 based on the device identification information. The print processing unit 230 is an example of a print data providing unit according to the present invention. Specifically, the print processing unit 230 transmits, to the printing device 52A, the print data of the cuter box label on which the individual identification information associated with the manufacturing machine number is displayed, and transmits, to the printing device 52B, the print data of the device housing label on which the individual identification information associated with the manufacturing machine number is displayed.

Upon receiving the device identification information (specifically, a manufacturing machine number), the check sheet processing unit 232 reads an electronic check sheet for performing inspection of the device to be set 9 for which the setting operation has been completed based on the received device identification information to transmit the read electronic check sheet to a tablet terminal 56.

The process management unit 234 menaces the process of each device to be set 9 based on the process ID. The process ID is updated every time the process is completed.

The ledger management unit 236 creates a device ledger in which the device identification information acquired by the handy terminal 54 and the unique setting file allocated by the allocation processing unit 228 are associated with each other. More specifically, the ledger management unit 236 creates and updates a device ledger in which the manufacturing machine number of the device to be set 9 acquired by the handy terminal 54, the unique setting file allocated to the device to be set 9 by the allocation processing unit 228, and the process ID of the device to be set 9 are associated with each other. The device ledger is settled as a ledger when all processes are completed.

The resource server 2B has a Dynamic Host Configuration Protocol (DHCP) server function for performing a master cloning on the connected device to be set 9 and a Preboot eXecution Environment (PXE) server function, and has an automatic setting scenario folder for performing automatic setting control. As storage destination of each resource, an operation log storage folder, a process management folder, an installation resource folder, and a master image storage folder are prepared in the resource server 2B.

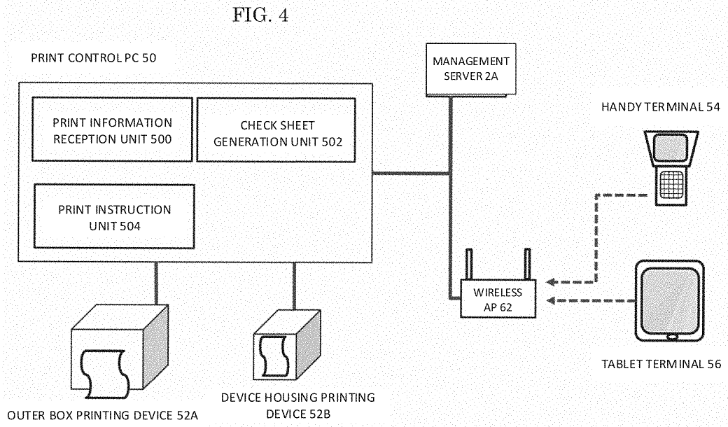

FIG. 4 is a diagram illustrating a relationship between the functional configuration of the print control PC 50 and the printing device 52.

As shown in FIG. 4, the print control PC 50 includes a print information reception unit 500 that receives print data transmitted from the handy terminal 54 via the web application of the management server 2A, a print instruction unit 504 that controls the printing device 52 to perform printing according to the received print data, and a check sheet generation unit 502 that generates an electronic check sheet.

FIG. 5 is a diagram illustrating a relationship between the functional configuration of the setting terminal 3 and the device to be set 9 with which the carriage 4 is loaded.

As illustrated in FIG. 5, the setting terminal 3 is connected to the plurality of key input control units 40 and the plurality of USB cameras 42 via the USB hub and the USB cable, and the key input control units 40 are connected to the plurality of PCs to be set 9 via the USB cable.

The key input control unit 40 includes a serial communication board 400 and a key input microcomputer board 410. The serial communication board 400 realizes communication by USB connection. The key input microcomputer board 410 is a microcomputer board that emulates the keyboard input to store a key operation scenario 412 which is a scenario defining the content, order, and timing of the keyboard input.

The plurality of USB cameras 42 is installed at positions facing the monitors of the plurality of PCs to be set 9 with which the carriage 4 is loaded, and photograph the display of the PCs to be set 9.

The setting terminal 3 includes a progress management unit 320 that manages the progress of the setting operation of the device to be set 9 (PC to be set 9) and a setting operation unit 330 that performs the setting operation of the device to be set 9. The setting terminal 3 stores an image restoration patch and a master image file for master cloning.

The progress management unit 320 is connected to the plurality of key input control units 40 and the plurality of USB cameras 42 via the USB hub and the USB cable, and manages and displays the progress of the setting operation for the plurality of devices to be set 9. Specifically, the progress management unit 320 performs the character recognition process on the image (photographed image of the monitor) captured by the USB camera 42, extracts a character string, and determines the progress of the scenario based on the extracted character string. For example, the progress management unit 320 performs the OCR process on the image (photographed image of the monitor) captured by the USB camera 42, extracts a character string, and determines whether the setting process in each setting step is normally completed based on the extracted character string.

In addition, the progress management unit 320 outputs a warning when a predetermined character string has not been extracted by a predetermined timing defined by a scenario.

The setting operation unit 330 is connected to the plurality of key input control units 40 via the USB hub and the USB cable, and controls input of setting information by the key input control unit 40.

The key input control unit 40 is USB connected to each of the devices to be set 9, and inputs sequentially individual setting information in parallel according to the scenario. The scenario includes an order of information to be input and a waiting time after input. Specifically, the key input control unit 40 sequentially inputs the setting information according to the key operation scenario 412.

A LAN hub and a LAN cable are prepared in the carriage 4, and each device to be set 9 with which the carriage 4 is loaded is connected to the setting terminal 3, the resource server 2B, and the management server 2A via the LAN hub and the LAN cable. The device to be set 9 with which the carriage 4 is loaded receives distribution of a common data file such as a master image via the LAN connection.

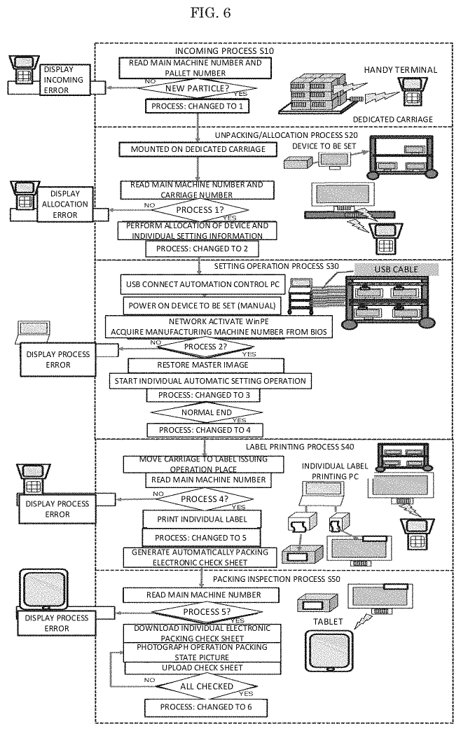

FIG. 6 is a flowchart describing an entire process in the setting management system 1.

As shown in FIG. 6, the entire process includes an incoming process S10, an unpacking/allocation process S20, a setting operation process S30, a label printing process S40, and a packing inspection process S50. For example, the unpacking/allocation process S20, the setting operation process S30, the label printing process S40, and the packing inspection process S50 are performed at different places, and these processes are performed by moving the carriage 4.

In the incoming process S10, when the device to be set 9 arrives, a manufacturing machine number and a pallet number of the device to be set 9 are acquired using the handy terminal 54 and transmitted to the management server 2. The incoming inspection unit 226 of the management server 2 stores the device information (manufacturing machine number) received from the handy terminal 54 in the device ledger in the setting operation DB 260 as a device list, and at the same time, the process management unit 234 records the process ID as “1”. When the already registered manufacturing machine number is read, the incoming inspection unit 226 displays an incoming error on the screen of the handy terminal 54.

In the unpacking/allocation process S20, the device to be set 9 to perform the setting operation is unpacked, mounted on the carriage 4, and the dedicated carriage barcode and the manufacturing machine number of the mounted device are read by the handy terminal 54 to confirm that the target manufacturing machine number is subjected to the incoming process by the present system and the process ID is “1”. When there is no problem, the allocation processing unit 228 of the management server 2 allocates the setting to the manufacturing machine number of the read device to be set 9, and the process management unit 234 changes the process ID of the target machine to “2”. When the process ID is not “1”, an allocation error is displayed on the screen of the handy terminal 54.

In the setting operation process S30, the device to be set 9 with which the carriage 4 is loaded is connected to the setting terminal 3 via a USB cable. When the power of the device to be set 9 is turned on, the device to be set 9 is activated in WinPE by PXE boot, and the setting terminal 3 acquires the manufacturing machine number of the device to be set 9 from the BIOS and confirms that the process ID is “2”. When there is no problem, individual automatic setting of the device to be set 9 is started based on the individual setting information allocated to the acquired manufacturing machine number. When the process ID is not “2”, a process error is displayed on the progress screen of the setting terminal 3. When notified of the start of the automatic setting from the setting terminal 3, the management server 2A (process management unit 234) changes the process ID to “3” at the start of the automatic setting, and changes the process ID to “4” at the normal end of the automatic setting.

In the label printing process S40, the printing device 52B prints a device housing label as an individual identification label on the device to be set 9 for which the setting operation S30 has been completed, and the printing device 52A prints an outer box label and these labels are attached. Specifically, the handy terminal 54 reads the manufacturing machine number of the device to be set 9, and confirms that the process ID of the target device is “4”. When there is no problem, the print processing unit 230 of the management server 2A provides the printing device 52A and the printing device 52B with the print data of the label in which the individual identification information associated with the manufacturing machine number is described in the setting operation DB 260, and one label for each is printed. When the process ID is not “4”, a process error is displayed on the screen of the handy terminal 54. After printing, the check sheet generation unit 502 generates data of an electronic check sheet to be used in the next process and makes the data downloadable, and the management server 2A (process management unit 234) changes the process ID of the device to be set 9 to “5”.

In the packing inspection process S50, the device to be set 9 to which the label is attached is moved to the packing operation place to perform the packing operation. The manufacturing machine number of the device to be set 9 is read by the tablet terminal 56, it is confirmed that the process ID of the device to be set 9 is “5”, and when there is no problem, the check sheet generation unit 502 downloads the electronic check sheet generated in the preceding process from the management server 2. According to the procedure described in the electronic check sheet, the package is checked, the state of the final packing state, and the attached label are photographed by the camera of the tablet terminal 56, evidence is acquired, and after the operation is completed, the process of uploading to the management server 2A is performed. At this time, the check sheet generation unit 502 checks whether all the items are checked with check marks, and in a case where there is an item without a check mark, the setting is such that the sheet cannot be uploaded. After the upload is completed, the process management unit 234 changes the process ID of the device to be set 9 to “6”.

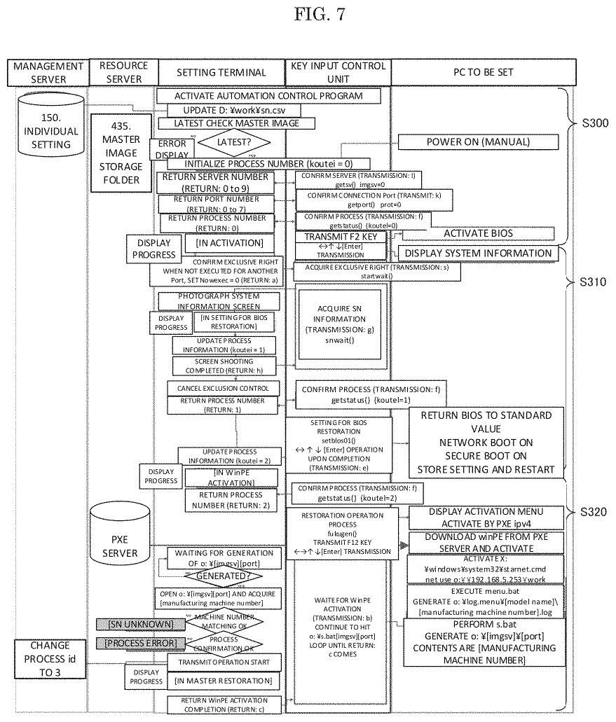

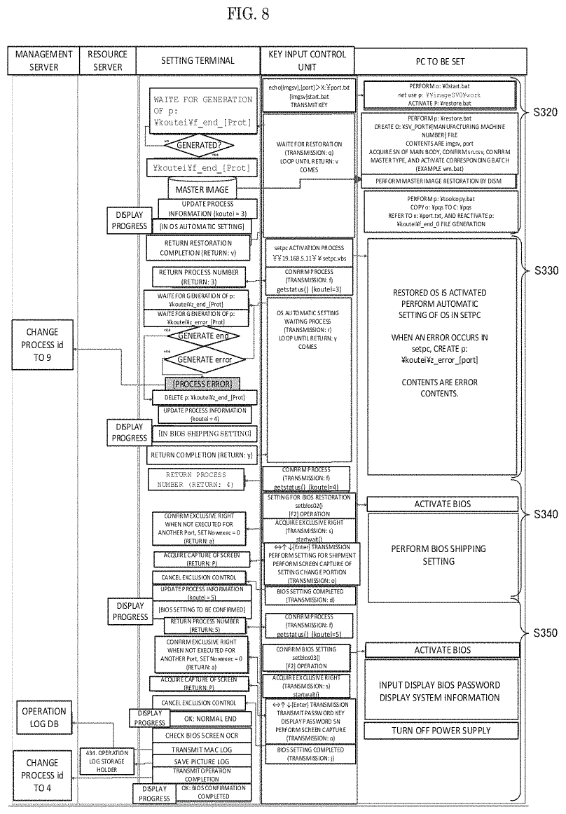

FIGS. 7 and 8 are flowcharts describing the setting operation process S30 in more detail.

As illustrated in FIGS. 7 and 8, the setting operation process S30 includes seven processes of an automatic control program activation process (S300), a master cloning preset process (S310), a master learning process (S320), an OS automatic setting process (S330), a BIOS setting process (S340), a BIOS setting portion screen photographing process (S350), and a BIOS setting confirmation process (S360). These processes sequentially proceed, and the progress management unit 320 of the setting terminal 3 displays “in activation” in S300, “in setting for BIOS restoration” in S310, “in WinPE activation” to “in master restoration” in S320, “in OS automatic setting” in S330, “in BIOS shipping setting” in S340, “BIOS setting to be confirmed” to “OK: normal end” in S350, and “OK: BIOS confirmation completed” in S360 on the monitor as the progress display.

In the automatic control program activation process (S300), the operator activates the setting operation unit 330 (automatic control program in the drawing) from the setting terminal 3.

In the activation process of the automatic control program, the setting operation unit 330 is connected to the management server 2A and automatically creates a definition file “D: ¥work¥sn.csv” to be used in the subsequent process based on the individual setting information stored in the management server 2A.

In addition, the setting operation unit 330 is connected to the master image storage folder of the resource server 2B and checks a difference from the master image stored in the setting terminal 3. When there is a difference, the setting terminal 3 displays an error screen and stops the process. When there is no problem in the processing so far, the progress management unit 320 initializes the process number for automation control (koutei=0), and the setting operation unit 330 (automatic control program) enters the execution standby state.

The key input control unit 40 starts transmission of the “F2 key” to the PC to be set 9.

The operator turns on the power of all the PCs to be set 9 for performing kitting, and presses the execution button of the automatic control program when confirming that the BIOS setting screen is displayed.

“In activation” is displayed in progress on the automatic control program, and the following processing is performed as control process of the key input control unit 40.
Transmission/reception of server number (command: getsv, argument: Imgsv=<management number>)
Transmission/reception of port numbers (command: getport, argument: Prot=<management number>)
Transmission/reception of process number (command: getstatus, argument: koutei=0)

In the mastering cloning preset process (S310), the key input control unit 40 that has received the process number (koutei=0) from the automatic control program controls the cursor key to display the system information screen of each PC to be set 9.

The setting operation unit 330 (automatic control program) causes the USB camera 42 to capture the system information screen displayed on the PC to be set 9 in order to record the kitting operation trail. At this time, each USB camera 42 performs the one-by-one photographing process in order to simplify association with each PC to be set and to speed up the photographing process. As the control, the exclusive right management process is performed between the setting operation unit 330 (automatic control program) and the key input control unit 40 (command: startwait, snwait).

When the photographing process completed, the progress management unit 320 displays the progress as “in setting for BIOS restoration”, and the setting operation unit 330 transmits a process number (koutei=l) of the next operation to the key input control unit 40.

When receiving the process number (koutei=l) from the setting operation unit 330 (automatic control program), key input control unit 40 activates the screen (setbios 01) corresponding to the process number, and controls the cursor key to perform the following BIOS setting.
Return BIOS to factory shipping state
Turn on network boot
Turn on secure boot
Save setting and reactivate

In the master cloning process (S320), the progress management unit 320 displays the progress as “in winPE activation”, and the setting operation unit 330 transmits a process number (koutei=2) of the next operation to the key input control unit 40. After the process number is transmitted, the setting operation unit 330 is in a standby state until the activation information is received from the PC to be set 9. When receiving the process number (koutei=2) from the setting operation unit 330 (automatic control program), key input control unit 40 activates the script (fukugen) corresponding to the process number, and activates the PC to be set 9 from the network by controlling the F12 key and the cursor key (PXE boot).

Thereafter, the key input control unit 40 shifts to the WindowsPE activation standby state and waits for information from the setting operation unit 330 (automatic control program).

The PC to be set 9 activated from the network downloads a WindowsPE image from the resource server 2B and activates it.

When the WindowsPE is activated by the PC to be set 9, the following is performed by the start up process.
Connection to resource server 2B (net use o: ¥¥192.168.5.253¥work)
Creation of connection log file (o: ¥Log.menu¥[model name]¥[manufacturing number].log)
Storage of activation completion information file (o: ¥[Imgsv][Port])

After confirming the storage of the activation completion information file (o: ¥[Imgsv][Port]), the setting operation unit 330 (automatic control program) acquires the manufacturing machine number described in the file, and inquires the management server 2A as follows.
Manufacturing machine number is present in management database (entry process is performed)
Already allocated to kitting progress state (process id=2)

When there is no problem, the setting terminal 3 notifies the management server 2A of the start of kitting, and the process management unit 234 of the management server 2A changes the process ID to “3”.

The progress management unit 320 displays the progress of “in master restoration”, and the setting operation unit 330 transmits a “WinPE activation completion return” to the key input control unit 40 to start the next process. After the transmission, it waits until the restoration completion information generation (p: ¥koutei¥f_end_0) from the PC to be set 9.

As illustrated in FIG. 8, the key input control unit 40 transmits the following keys to the PC to be set 9. After the transmission, the process waits until “restoration completion” is received from the setting operation unit 330 (automatic control program).
Connection to the setting terminal 3 (o: ¥[server management number]start.bat)
Perform master cloning (p: ¥restore.bat)
Check the contents of “D: ¥work¥sn.csv” and select the master image associated with the manufacturing machine number
Check the contents of “D: ¥work¥sn.csv” and perform partitioning associated with the manufacturing machine number.
Master image cloning by DISM
Generate restoration completion information (p: ¥koutei¥f_end_0)

After confirming the restoration completion information (p: ¥koutei¥f_end_0), the setting operation unit 330 (automatic control program) transmits the process information (koutei=3) to the key input control unit 40, and the progress management unit 320 changes the progress display to “in OS automatic setting”.

In the OS automatic setting process (S330), the key input control unit 40 key transmits “¥¥192.168.5.11¥pqs¥setpc.vbs<1}” to the PC to be set 40. The PC to be set 9 activates the restored OS and executes setpc.vbs. By setpc.vbs, an automation scenario activates a keyboard mouse operation, and performs automatic setting on the OS.

The key input control unit 40 confirms the process number with respect to the setting terminal 3 and acquires (koutei=3).

The setting operation unit 330 waits by looping until “z_end_[port number]” or “z_error_[port number]” is generated in the “koutei” folder.

The key input control unit 40 waits in a loop until “y” is transmitted from the setting terminal 3.

The PC to be set 9 generates the “z_end_[port number]” file in the “koutei” folder when the automatic setting of the OS is completed. When confirming the existence of z_end_[port number] in the “koutei” folder, the setting operation unit 330 determines that the automation of the PC to be set 9 is completed and deletes the “z_end_[port number]” file, and the progress management unit 320 sets “koutei=4”.

The progress management unit 320 changes the progress display to [in BIOS shipping setting], and the setting operation unit 330 transmits “y” to the key input control unit 40 to notify that the automation of the OS is finished.

When an error occurs during the setting operation, the PC to be set 9 generates “z_error_[port number]” in the “koutei” folder. When the progress management unit 320 of the setting terminal 3 confirms the presence of “z_error-[port number]” in the “koutei” folder, it displays an error in the progress display, and the setting operation unit 330 stops the operation.

In the BIOS setting process (S340), the key input control unit 40 checks the process number for the setting terminal 3, acquires “koutei=4”, and then transmits the [F2] key to the PC to be set 9 to activate the BIOS.

The PC to be set 9 is in a state in which the BIOS screen is open by operating the F2 key.

In order to acquire the right of use of the USB camera 42 for photographing the BIOS setting state, the key input control unit 40 transmits “s” to the setting terminal 3 to confirm the right of use.

When not used in another port, the setting terminal 3 returns “a” to the key input control unit 40 and passes the exclusive use right of the USB camera 42.

The key input control unit 40 repeats key transmission and performs shipment setting of the BIOS. In a case where the change is made, the key input control unit 40 transmits a photographing request “o” to the setting terminal 3.

After photographing the setting screen of the PC to be set 9 using the USB camera 42, the setting terminal 3 returns completion of photographing “p” to the key input control unit 40.

When the key input control unit 40 transmits “d” to the setting terminal 3 after completing the setting of the entire BIOS, the setting terminal 3 cancels the exclusive right of the USB camera 42, the progress management unit 320 sets “koutei=5” and changes the progress display to “BIOS setting to be confirmed”.

In the BIOS setting portion screen photographing process (S350), the key input control unit 40 confirms the process number for the setting terminal 3 (progress management unit 320), acquires “koutei=5”, and then transmits the “F2” key to the PC to be set 9 to activate the BIOS.

The PC to be set 9 opens the BIOS screen by operating the F2 key.

In order to acquire the right of use of the USB camera 42, the key input control unit 40 transmits “s” to the setting terminal 3 to confirm the right of use.

When not used in another port, the setting terminal 3 returns “a” to the key input control unit 40 and passes the exclusive use right of the USB camera 42.

The key input control unit 40 repeats the key transmission, and inputs the BIOS password performed in the BIOS shipment setting. The key input control unit 40 transmits a photographing request “o” to the setting terminal 3 in a state where the BIOS screen is opened. The setting terminal 3 photographs the setting screen of the PC to be set 9 using the USB camera 42, and then returns photographing completion “p”.

When the key input control unit 40 performs the power disconnection from the BIOS for the PC to be set 9 and then transmits “j” to the setting terminal 3, the setting terminal 3 cancels the exclusive right of the USB camera 42, the progress management unit 320 sets “koutei=6” and changes the progress display to “OK: Normal end”.

In the BIOS setting confirmation process (S360), the progress management unit 320 of the setting terminal 3 performs the OCR process on the picture taken during the BIOS setting, converts the picture into text, and checks whether there is no mistake in the setting contents. When there is an error in reading the OCR process, the corresponding picture is displayed on the screen of the setting terminal 3, and a dialog asking the operator to make a quality determination is displayed.

After the checking through the OCR process of the BIOS screen, the setting terminal 3 collects the MAC address of the PC to be set 9 from the operation log, and registers the MAC address in setting operation DB 260 of management server 2A. The picture of the BIOS screen and the log file acquired by the OS automation are moved to the operation log storage folder of the resource server 2B. When the setting terminal 3 notifies the setting operation DB 260 of the management server 2A of the manufacturing machine number of the PC to be set 9, the process management unit 234 of the management server 2A changes the process ID of the manufacturing machine number to “4”, and the progress management unit 320 of the setting terminal 3 changes the progress display to “OK: BIOS confirmation completed”.

Thus, the setting operation process (S30) is completed.

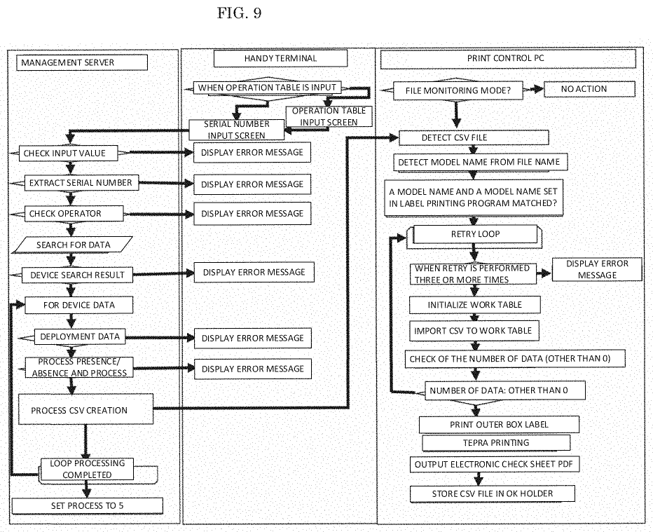

FIG. 9 is a flowchart describing the label printing process S40 in more detail.

As illustrated in FIG. 9, the input state of the carriage 4 is confirmed by the handy terminal 54, and when there is no problem, the manufacturing machine number is input on the input screen of the manufacturing machine number. When the identification information of the carriage 4 is not input, an input screen of the operation table identification information is displayed, and an input screen of the manufacturing machine number is displayed after the input.

After inputting the manufacturing machine number, the management server 2A performs an input value check, extraction of the manufacturing machine number, and an operator check to search for data. The process ID is confirmed from the retrieved development data, a CSV file including an item to be printed is created, and the process management unit 234 changes the process ID of the device to be set 9 to “5”.

The print control PC 50 detects the CSV file, detects a model name from the file name, checks whether the model name matches the model name set in the print instruction unit 504, imports the CSV file to the worktable, and checks the number of data.

In a case where the number of data is 0, the print control PC 50 performs import of the CSV three times, and displays an error message in a case where the number of times is three or more.

When the number of data items is other than 0, the print control PC 50 causes the printing device 52A and the printing device 52B to print the outer box label and the device housing label, outputs the electronic check sheet as a PDF file to store the imported CSV file in the OK folder.

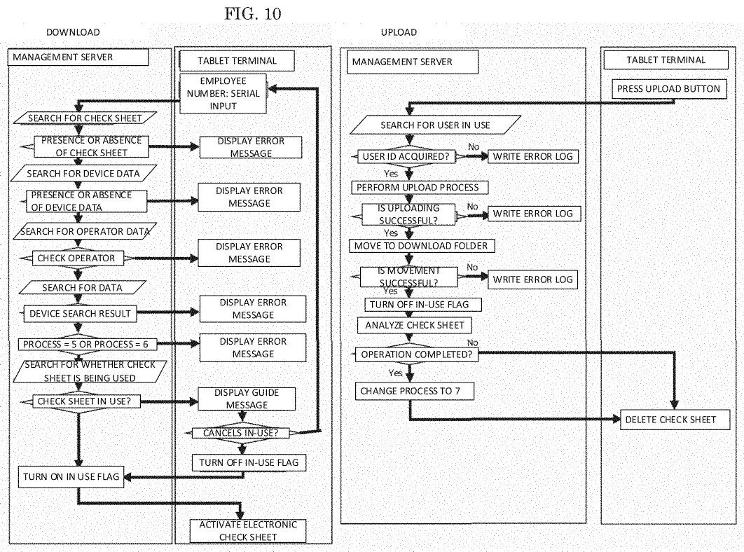

FIG. 10 is a flowchart describing the packing inspection process S50 in more detail.

As illustrated in FIG. 10, in a scene of downloading the electronic check sheet, the employee number and the manufacturing machine number are input to the tablet terminal 56. The management server 2A searches the electronic check sheet from the input employee number and the manufacturing machine number, and checks the presence or absence of the electronic check sheet. When there is no electronic check sheet, an error message is displayed.

When there is a check sheet, device data is searched from the input manufacturing machine number, and the presence or absence thereof is checked. When there is no device data, an error message is displayed.

When there is the device data, the operator data is searched for from the input employee number. When there is no operator data, an error message is displayed.

When there is the operator data, the device data is searched for, and the process ID of the PC to be set 9 is changed to “6”.

Whether the check sheet is being used is searched, and when the check sheet is being used, a guidance message is displayed. When the electronic check sheet can be used, the tablet terminal 56 downloads the target electronic check sheet from the management server 2A.

In a scene of uploading the electronic check sheet, after the checking operation by the electronic check sheet is completed, the user presses the “upload” button on the tablet terminal 56. The tablet terminal 56 searches for a user who is using, acquires a user ID, and performs an electronic check sheet upload process for the management server 2. When the user ID cannot be acquired, an error log is output and the process is stopped.

The check sheet processing unit 232 of the management server 2 confirms that the electronic check sheet has been successfully uploaded, and when there is no problem, the file is moved to the download folder, so that the file can be downloaded in the checked state. When the upload failure or the movement failure to the download folder occurs, the check sheet processing unit 232 outputs an error log and is stopped. The checking status of the electronic check sheet whose movement has been completed is analyzed, and when all completed, the process management unit 234 changes the process ID to “7”. The tablet terminal 56 deletes the electronic check sheet data on the tablet terminal 56.

As described above, according to the setting management system 1 of the present embodiment, the setting operation of the plurality of PCs to be set 9 can be performed in parallel in a flow operation. The setting information set in the PC to be set 9 is individual information, and a label that can distinguish the setting information is attached.

The setting operation of the PC to be set 9 is automated, and it is sufficient for the operator to cope with the situation only when an error or the like occurs.

In addition, according to the setting management system 1, it is possible to grasp the progress of operation in real time at a kitting site where unpacking, allocation, setting, packing, and the like are performed by flow operation.

### REFERENCE SIGNS LIST

1 setting management system
2A management server
2B resource server
3 setting terminal
320 progress management unit
330 setting operation unit
4 carriage
40 key input control unit
42 USB camera

1. A setting terminal comprising:
a USB cable that is USB connected to the device to be set and inputs information to the device to be set; and
a memory; and
a processor coupled to the memory and the processor configured to:
store a scenario of a setting process related to a device to be set;
determine a progress of the scenario of the setting process based on timing of the input and the stored scenario; and
input, to the device to be set, a setting information according to the determined progress of the scenario.

2. The setting terminal according to claim 1, wherein
the setting information includes information to be input before an operating system is activated; and the processor is configured to:
emulate a keyboard input and input the setting information to the device to be set.

3. The setting terminal according to claim 1, further comprising:
a camera that photograph a display of the device to be set; and wherein the processor is further configured to:
determine a progress of a setting process based on the captured image.

4. The setting terminal according to claim 3, further comprising:
a plurality of input devices;
a plurality of imaging devices; and wherein the processor is configured to:
input setting information to a plurality of devices to be set in parallel via the plurality of input devices; and
determine a progress of a setting process of each of the plurality of devices to be set based on as image captured by each of the plurality of imaging devices.

5. The setting terminal according to claim 4, wherein the processor is further configured to:
acquire device identification information from the devices to be set;
input, to the devices to be set, the setting information unique to each of acquired pieces of device identification information.

6. The setting terminal according to claim 5, further comprising:
a network interface connected to the devices to be set via a LAN cable; the processor is configured to:
input the setting information unique to each of the plurality of devices to be set; and
distribute, a master image to the plurality of devices to be set via the network interface.

7. The setting terminal according to claim 3, wherein the processor is configured to:
perform a character recognition process on the captured image, extract a character string, and determine the progress of the scenario based on the extracted character string.

8. The setting terminal according to claim 7, wherein the processor is configured to:
output a warning when a predetermined character string is not extracted by predetermined timing defined by the stored scenario.

9. A setting method comprising the steps of:
performing a USB connection with a device to be set and inputting setting information to the device to be set;
determining a progress of a scenario of a setting process based on timing of the input by the input step and a scenario of a setting process related to the device to be set; and
inputting next setting information to the device to be set according to the determined progress of the scenario.

10. A non-transitory computer-readable recording medium storing thereon a computer program that causes a computer to perform a method comprising:
performing a USB connection with a device to be set and inputting setting information to the device to be set;
determining a progress of a scenario of a setting process based on timing of the input by the input step and a scenario of a setting process related to the device to be set; and
inputting next setting information to the device to be set according to the determined progress of the scenario.
